(19) United States
(12) Patent Application Publication
(10) Pub. No.: US 2012/0307649 A1
(43) Pub. Date: Dec. 6, 2012

(54) CHANNEL STATUS INFORMATION FEEDBACK APPARATUS AND METHOD FOR SAME, BASE STATION, AND TRANSMISSION METHOD OF SAID BASE STATION

(75) Inventors: Kyoungmin Park, Seoul (KR); Jianjun Li, Seoul (KR)

(73) Assignee: PANTECH CO., LTD., Seoul (KR)

(21) Appl. No.: 13/578,229

(22) PCT Filed: Feb. 10, 2011
(86) PCT No.: PCT/KR11/00907

§ 371 Date: Aug. 9, 2012

(30) Foreign Application Priority Data
Feb. 12, 2010 (KR) 10-2010-0013400

(51) Int. Cl. H04W 24/00

(52) U.S. Cl. 370/241

(57) ABSTRACT

A method and wireless communication system using a multi-input multi-output (MIMO) antenna generate vectors and feedback channel status information.

### CROSS-REFERENCE TO RELATED APPLICATIONS

This application is the National Stage Entry of International Application PCT/KR2011/000907, filed on Feb. 10, 2011, and claims priority from and the benefit of Korean Patent Application No. 10-2010-0013400, filed on Feb. 12, 2010, both of which are incorporated herein by reference for all purposes as if fully set forth herein.

### BACKGROUND

1. Field

The present disclosure relates to a wireless communication system using a multiple-input multiple-output (MIMO) antenna.

### DISCUSSION OF THE BACKGROUND

As communication systems have developed, various wireless terminals have been utilized by consumers, such as companies and individuals.

A current mobile communication system, for example, 3GPP, Long Term Evolution (LTE), LTE-Advanced (LTE-A), and the like, may be a high capacity communication system capable of transmitting and receiving various data such as image data, wireless data, and the like, beyond providing a sound-based service. Accordingly, there is a desire for a technology that transmits high capacity data, which is comparable with a wired communication network. Also, the system is required to include an appropriate error detection scheme that increases transmission efficiency of the system so as to improve performance of the system.

A communication system based on a multiple-input multiple-output (MIMO) antenna is used in both a transmitting end and a receiving end. This has a structure in which a single UE (SU) or multiple UEs may receive/transmit a signal from/to a single base station (BS) and the like.

The system using the MIMO scheme may recognize a channel status based on various reference signals and the like, and may feed back the recognized channel status to a transmitting end (another device).

That is, when a single UE is assigned with a plurality of downlink (DL) physical channels, the UE may feed back channel status information associated with each of the physical channels to a BS so as to adaptively optimize the system. To achieve the above, signals, such as a channel status index-reference signal (CSI-RS), a channel quality indicator (CQI), and a precoding matrix index (PMI), may be utilized, and the BS may perform channel scheduling based on information associated with a channel status.

### SUMMARY

In accordance with an aspect of the present invention, there is provided a channel status information feedback method, the method including: generating a first vector by transforming, based on a predetermined scheme, a component vector associated with a few of an m number of layers and an n number of antennas in a channel matrix indicating a downlink (DL) channel status transmitted through the m layers and the n antennas, m being a natural number greater than or equal to 2 and n being a natural number greater than or equal to m; generating a second vector by transforming, based on another scheme, a component vector associated with another few of the m layers and the n antennas in the channel matrix; and transmitting, to a base station (BS), the first vector and the second vector, or information designating the first vector and the second vector.

In accordance with another aspect of the present invention, there is provided a channel status information feedback method, the method including: generating a vector that has row vectors having the same power, and that is transformed from a channel matrix indicating a DL channel status transmitted through m layers and n antennas, m being a natural number greater than or equal to 2 and n being a natural number greater than or equal to m; and transmitting, to a BS, the vector or information designating the vector, at the same point in time or at different points in time.

In accordance with another aspect of the present invention, there is provided a channel status information feedback apparatus in a wireless communication system, the apparatus including: a reference signal receiving unit to receive a reference signal from a BS; a channel estimation unit to estimate a channel based on the received reference signal; a channel status information generating unit to generate channel status information including a first vector obtained by transforming, based on a predetermined scheme, a component associated with a few of an m number of layers and an n number of antennas in a channel matrix indicating a DL channel status transmitted through the m layers and the n antennas based on a result of the channel estimation of the channel estimating unit, and a second vector obtained by transforming, based on another scheme, a component vector associated with another few of the m layers and the n antennas in the channel matrix, m being a natural number greater than or equal to 2 and n being a natural greater than or equal to m; and a feedback unit to feed back the generated channel status information.

In accordance with another aspect of the present invention, there is provided a channel status information feedback apparatus in a wireless communication system, the apparatus including: a reference signal receiving unit to receive a reference signal from a BS; a channel estimation unit to estimate a channel based on the received reference signal; a channel status information generating unit to generate channel status information including a vector that has row vectors having the same power, and that is transformed from a channel matrix indicating a DL channel status transmitted through m layers and n antennas, m being a natural number greater than or equal to 2 and n being a natural number greater than or equal to m; and a feedback unit to feed back the generated channel status information.

In accordance with another aspect of the present invention, there is provided a BS in a wireless communication system, the BS including: a layer mapper to perform mapping of a codeword on a layer; a precoder to perform precoding of mapped symbols based on a precoding matrix; an antenna array including two or more antennas that propagate the precoded symbols into air; and a precoder generating unit to generate a precoding matrix of user equipments (UEs) based on channel status information including a first vector obtained by transforming, based on a predetermined scheme, a component vector associated with a few of an m number of layers and an n number of antennas in a channel matrix indicating a downlink (DL) channel status, transmitted through the m layers and the n antennas and reported from the UEs, and a second vector obtained by transforming, based on another scheme, a component vector associated with another few of the m layers and the n antennas, m being a natural number greater than or equal to 2 and n being a natural number greater than or equal to m.

In accordance with another aspect of the present invention, there is provided a BS in a wireless communication system, the BS including: a layer mapper to perform mapping of a codeword on a layer; a precoder to perform precoding of mapped symbols based on a precoding matrix; an antenna array including two or more antennas that propagate the precoded symbols into air; and a precoder generating unit to generate a precoding matrix of UEs based on channel status information including a vector that has row vectors having the same power, and that is transformed from a channel matrix indicating a DL channel status transmitted through m layers and n antennas, m being a natural number greater than or equal to 2 and n being a natural number greater than or equal to m.

In accordance with another aspect of the present invention, there is provided a transmission method in a wireless communication system, the method including: mapping a codeword on a layer; precoding mapped symbols based on a precoding matrix; transmitting precoded symbols into air through use of an antenna array including two or more antennas; and generating a precoding matrix of UEs based on channel status information including a first vector obtained by transforming, based on a predetermined scheme, a component vector associated with a few of an m number of layers and an n number of antennas in a channel matrix that indicates a DL channel status, transmitted through the m layers and the n antennas and reported from the UEs, and a second vector obtained by transforming, based on another scheme, a component vector associated with another few of the m layers and the n antennas, m being a natural number greater than or equal to 2 and n being a natural number greater than or equal to m.

In accordance with another aspect of the present invention, there is provided a transmission method in a wireless communication system, the method including: mapping a codeword on a layer; precoding mapped symbols based on a precoding matrix; transmitting precoded symbols into air through an antenna array including two or more antennas; and generating a precoding matrix of UEs based on channel status information including a vector that has row vectors having the same power, and that is transformed from a channel matrix indicating a DL channel status transmitted through m layers and n antennas, m being a natural number greater than or equal to 2, and n being a natural number greater than or equal to m.

### BRIEF DESCRIPTION OF THE DRAWINGS

FIG. 1 is a diagram illustrating a wireless communication system according to an embodiment of the present invention;

FIG. 2 is a functional block diagram illustrating a channel status information feedback apparatus in an MIMO system according to an embodiment of the present invention;

FIG. 3 is a block diagram illustrating a channel status information generating unit of FIG. 2;

FIG. 4 is a flowchart illustrating a channel status information feedback method in a MIMO system according to another embodiment of the present invention;

FIG. 5 is a flowchart illustrating an example of a channel status information generating method according to another embodiment of the present invention;

FIG. 6 is a flowchart illustrating another example of a channel status information generating method according to another embodiment of the present invention;

FIG. 7 is a block diagram illustrating a base station (BS) according to another embodiment of the present invention; and

FIG. 8 is a flowchart illustrating a transmission method of a BS according to another embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

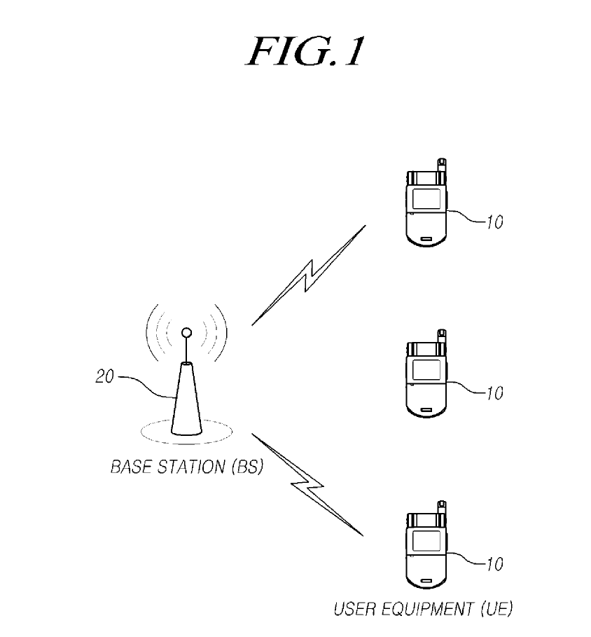

FIG. 1 illustrates a wireless communication system according to an embodiment of the present invention.

The wireless communication system may be widely installed so as to provide various communication services, such as a voice service, packet data, and the like.

Referring to FIG. 1, the wireless communication system may include a user equipment (UE) 10 and a base station (BS) 20.

In the specifications, the UE 10 may be an inclusive concept indicating a user terminal utilized in wireless communication, including a UE in WCDMA, Long Term Evolution (LTE), HSPA, and the like, and a mobile station (MS), a user terminal (UT), a subscriber station (SS), a wireless device and the like in GSM.

The BS 20 or a cell may refer to a fixed station where communication with the UE 10 is performed, and may also be referred to as a Node-B, an evolved Node-B (eNB), a base transceiver system (BTS), an access point, a relay node, and the like.

In the specifications, the UE 10 and the BS 20 are used as two inclusive transceiving subjects to embody the technology and technical concepts described in the specifications, and may not be limited to a predetermined term or word.

An embodiment of the present invention may be applicable to an asynchronous wireless communication scheme that is advanced through GSM, WCDMA, and HSPA, to be LTE and LTE-advanced, and may be applicable to a synchronous wireless communication scheme that is advanced through CDMA and CDMA-2000, to be UMB. Embodiments of the present invention may not be limited to a specific wireless communication scheme, and may be applicable to all technical fields to which a technical idea of the present invention is applicable.

The wireless communication system may support an uplink (UL) and/or a downlink (DL) HARQ, and a channel quality indicator (CQI) may be used for link adaptation. Also, a multiple access scheme for a DL and a multiple access scheme for a UL may be different from each other. For example, a DL may use an orthogonal frequency division multiple access (OFDMA) and a UL may use a single carrier-frequency division multiple access (SC-FDMA).

To support a high speed information transmission to many users, the wireless communication system may need a scheme that increases a peak spectral efficiency that may be provided to a user having a good channel status, and a scheme that increases a cell average spectral efficiency and a cell edge spectral efficiency of a user in a poor channel environment.

To achieve the latter two purposes, the latest communication schemes may consider using a multiple user multiple-input multiple-output (MU-MIMO) scheme that simultaneously transfers information to many users through a multi-antenna. When two or more users have a high channel propagation gain with respect to the same band, the MU-MIMO scheme may allow the two users to share a band and may enable many users to use a band where a channel propagation gain is good in addition to having a gain by using a wide band and thus, a spectral efficiency may be generally increased.

A drawback of the MU-MIMO scheme is that channel status information associated with a channel needs to be transferred to a BS. In the case of SU-MIMO scheme, multiple access interference (MAI) may not need to be considered, and each user may transfer a transmission scheme appropriate for a channel or a PMI associated with an MIMO transmission scheme (precoding matrix), as opposed to directly transferring information associated with the channel and thus, excellent performance may be readily provided.

However, the MU-MIMO may require correlation between antennas or detailed information associated with a unique characteristic of a virtual channel or a physical channel such as an eigenvector and the like, for controlling interference between users. In the case of the MU-MIMO scheme, each UE may transfer direct information associated with the channel to the BS so that the BS may recognize interference between the users and may perform appropriate scheduling. Each UE may need to support the BS so that the BS performs precoding and scheduling to prevent interference between the users based on the information. Directly transferring the channel status information may cause very huge feedback overhead and thus, a rational channel status information transferring scheme may need to be developed.

Conversely, the SU-MIMO scheme may be operated even when direct information associated with a precoder that may provide an excellent precoding gain or information that is more unclear than the correlation between antennas is provided, as opposed to the information associated with the channel. It is because the SU-MIMO scheme may control interference between layers based on a receiving end scheme such as interference removal.

Based on the characteristics of the SU/MU-MIMO schemes, the SU-MIMO scheme and the MU-MIMO scheme may be operated based on different feedback information from each other, or may be operated based on the same feedback information of which a portion is designed to have higher-precision than a remaining portion. According to the latter of the two schemes, both or one of the SU/MU-MIMO schemes may be embodied based on the entire feedback information and thus, the latter scheme may have a higher feedback efficiency than the former scheme in which each of the SU/MU-MIMO schemes is embodied based on a portion of the feedback information, or may have an excellent MIMO performance for the same feedback overhead.

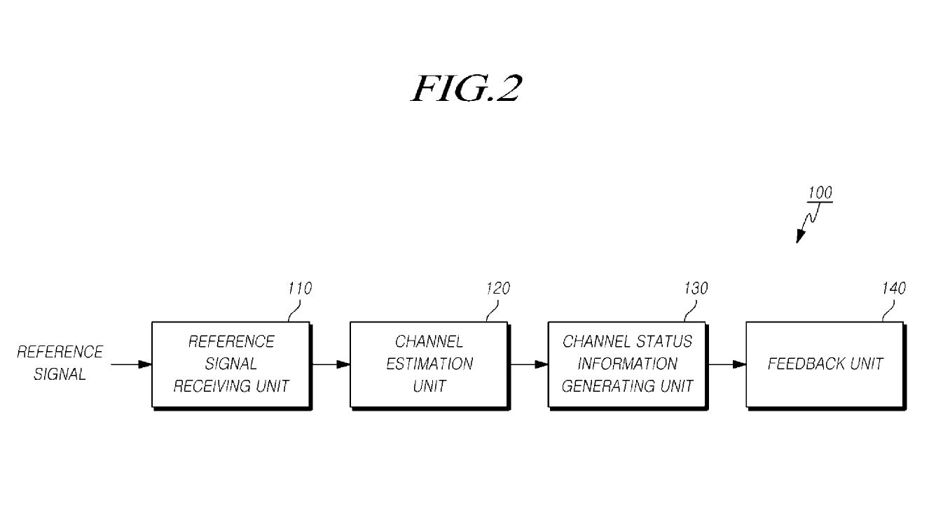

Hereinafter, a feedback method and a precoding method that may embody the SU/MU-MIMO schemes through use of a feedback having the same structure may be provided. Also, a method of embodying a feedback signal that is advantageous to each of the SU/MU-MIMO schemes for the feedback overhead based on the characteristics of the SU/MU-MIMO schemes will be described with reference to FIGS. 2 through 8.

FIG. 2 illustrates a channel status information feedback apparatus in an MIMO system according to an embodiment of the present invention.

An MIMO channel status information feedback apparatus 100 may be embodied as hardware or software in an existing UE that is currently connected or an additional UE that attempts connection, but this may not be limited thereto and may be embodied in a BS and the like.

The MIMO channel status information feedback apparatus 100 may include a reference signal receiving unit 110 to receive, from the BS, a reference signal, for example, a channel state index-reference signal (CSI-RS), a channel estimation unit 120 to estimate a channel based on the received CSI-RS, a channel status information generating unit 130 to generate corresponding channel status information based on a channel estimation result of the channel estimation unit, and a feedback unit 140 to feed back the generated channel status information.

The reference signal receiving unit 110 and the channel estimation unit 120 may be embodied separately or integrally, and may be embodied integrally as occasion demands.

The reference signal receiving unit 110 may receive a CSI-RS unique to a cell, and may have information associated with at which band (subcarrier) of a reception signal and at which symbol the CSI-RS is received and thus, may measure a CSI-RS reception value by determining a signal of a corresponding time-frequency domain.

The CSI-RS may be a reference signal that is transmitted by the BS so that the UE may estimate a DL channel. The UE may receive the CSI-RS and may perform DL channel estimation, and may search for a precoding (PC) scheme and a post-decoding (PDC) scheme appropriate for the estimated channel.

The channel estimation unit 120 may perform a function of estimating a channel based on the received CSI-RS, and the channel estimation may be performed as follows.

A reception value of the CSI-RS received by the reference signal receiving unit 110 may be expressed by Equation 1. In Equation 1, r̅^{RS} denotes a reception value of a received CSI-RS, H denotes a propagation channel, t̅^{RS} denotes a transmission value of a transmitted CSI-RS, and η̅ denotes Gaussian noise.

r̅^{RS}=H t̅^{RS}+ η̅ [Equation 1]

r̅^{RS} corresponding to the reception value of the received CSI-RS may be obtained through the above measurement, and t̅^{RS} corresponding to the transmission value of the CSI-RS may be a value that is known to the BS and the UE. Accordingly, H corresponding to the propagation channel may be estimated through use of a general channel estimation scheme.

The propagation channel H which is a result of the channel estimation performed by the channel estimation unit 120 may be a channel matrix or a covariance matrix. In the specifications, the channel estimation result may be referred to as a channel matrix.

The channel status information generating unit 140 may generate channel status information based on the channel estimation result of the channel estimation unit 120.

The channel status information may include a first vector that is obtained by transforming, based on a predetermined scheme, a component vector associated with a few of an m number of layers and an n number of antennas in a channel matrix indicating a DL channel status, transmitted through the m layers and the n antennas, and a second vector that is obtained by transforming, based on another scheme, a component vector corresponding to another few of the m layers and the n antennas in the channel matrix, m being a natural number greater than or equal to 2 and n being a natural number greater than or equal to m, or the channel status information may include information designating the first vector and the second vector. The channel status information may include a vector that has row vectors having the same power, and that is obtained by transforming component vectors of the channel matrix that indicates the DL channel status transmitted through the m layers and the n antennas. Also, the channel status information may include information associated with a channel quality, for example, a channel quality indicator (CQI) value. Hereinafter, quantization will be described as an example of the method of transforming the channel matrix, the method may not be limited thereto.

Component elements of the channel status information feedback apparatus in the MIMO system according to an embodiment of the present invention have been described. Hereinafter, a channel status information generating unit, which is one of the component elements of the channel status information feedback apparatus in the MIMO system, will be described.

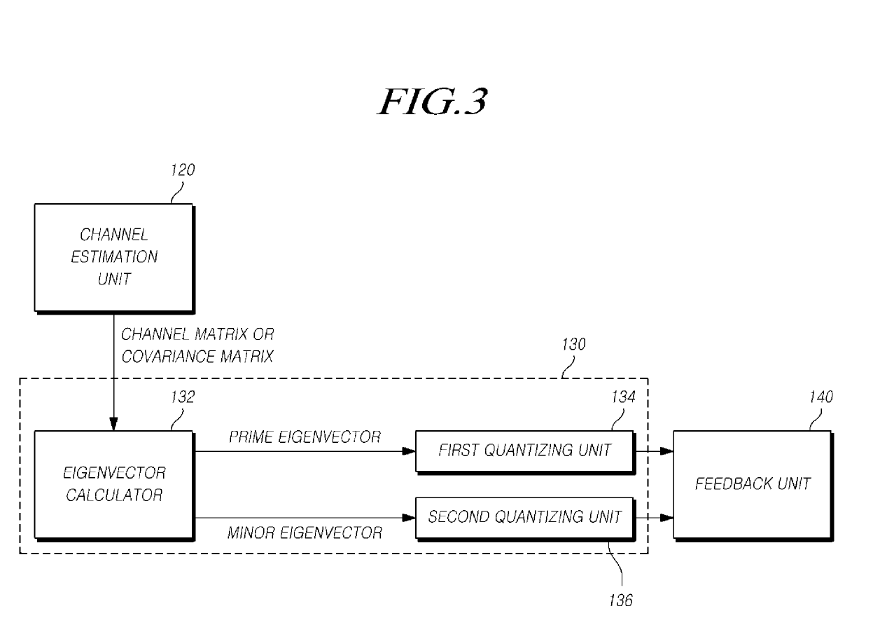

FIG. 3 illustrates the channel status information generating unit of FIG. 2.

The channel status information generating unit 140 may include an eigenvector calculator 132, a first quantizing unit 134, and a second quantizing unit 136.

Although the first quantizing unit 134 and the second quantizing unit 136 may be separately described, the first quantizing unit 134 and the second quantizing unit 135 may be embodied separately or integrally, and may be embodied integrally as occasion demands.

The eigenvector calculator 132 may calculate an eigenvector or a unique vector (characteristic vector) of a channel matrix or a covariance matrix that is a result of channel estimation performed by the channel estimation unit 120. For example, the eigenvector calculator 132 may calculate the eigenvector of the channel matrix through use of a Hermitian matrix formed by multiplication of a channel matrix having a conjugate transpose as shown in Equation 2, but this may not be limited thereto.

H*H=EËE*[Equation 2]

Here, H denotes a channel matrix of Equation 1, E denotes an eigenvector, symbol * denotes a conjugate transpose, and Ë denotes a diagonal matrix of an eigenvector.

For example, with respect to a channel formed of 4 layers (m=4) and 4 antennas (n=4), the eigenvectors of the channel matrix or the covariance matrix calculated by the eigenvector calculator 132 may be as shown in Equation 3.

$$\frac{1}{3} [ \begin{matrix}2.4 ∠52° \\ 0.8 ∠314° \\ 1.6 ∠37° \\ 0.2 ∠142°\end{matrix} ] \frac{1}{4} [ \begin{matrix}3.5 ∠27° \\ 1.8 ∠284° \\ 0.4 ∠62° \\ 0.6 ∠154°\end{matrix} ] \frac{1}{3} [ \begin{matrix}1.6 ∠84° \\ 1.3 ∠96° \\ 0.5 ∠196° \\ 2.1 ∠312°\end{matrix} ] \frac{1}{3} [ \begin{matrix}1.5 ∠271° \\ 2.4 ∠142° \\ 0.8 ∠342° \\ 0.6 ∠28°\end{matrix} ] \qquad [ Equation 3 ]$$

The eigenvectors that are calculated by the eigenvector calculator 132 from the channel matrix may be quantized by the first quantizing unit 134 and/or the second quantizing unit 136 through use of amplitude information and phase information, or through use of only phase information having high-precision. For example, vectors obtained by quantizing the 4 eigenvectors in Equation 3 through use of 2 pieces of amplitude information and 8 pieces of phase information may be expressed by Equation 4, and vectors obtained by quantizing the 4 eigenvectors through use of only 16 pieces of is phase information may be expressed by Equation 5.

$$\begin{matrix}\frac{1}{\sqrt{10}} [ \begin{matrix}2 {e}^{j π \text{/} 4} \\ {e}^{j 7 π \text{/} 4} \\ 2 {e}^{j π \text{/} 4} \\ {e}^{j 3 π \text{/} 4}\end{matrix} ] \frac{1}{\sqrt{10}} [ \begin{matrix}2 {e}^{j π \text{/} 4} \\ 2 {e}^{j 6 π \text{/} 4} \\ {e}^{j π \text{/} 4} \\ {e}^{j 3 π \text{/} 4}\end{matrix} ] \frac{1}{\sqrt{10}} [ \begin{matrix}2 {e}^{j 2 π \text{/} 4} \\ {e}^{j 2 π \text{/} 4} \\ {e}^{j 4 π \text{/} 4} \\ 2 {e}^{j 7 π \text{/} 4}\end{matrix} ] \frac{1}{\sqrt{10}} [ \begin{matrix}2 {e}^{j 6 π \text{/} 4} \\ 2 {e}^{j 3 π \text{/} 4} \\ {e}^{j 8 π \text{/} 4} \\ {e}^{j π \text{/} 4}\end{matrix} ] & [ Equation 4 ] \\ [ \begin{matrix}{e}^{j 1 π \text{/} 8} \\ {e}^{j 13 π \text{/} 8} \\ {e}^{j 2 π \text{/} 8} \\ {e}^{j 6 π \text{/} 8}\end{matrix} ] [ \begin{matrix}{e}^{j π \text{/} 8} \\ {e}^{j 13 π \text{/} 8} \\ {e}^{j 3 π \text{/} 8} \\ {e}^{j 7 π \text{/} 8}\end{matrix} ] [ \begin{matrix}{e}^{j 4 π \text{/} 8} \\ {e}^{j 4 π \text{/} 8} \\ {e}^{j 9 π \text{/} 8} \\ {e}^{j 14 π \text{/} 8}\end{matrix} ] [ \begin{matrix}{e}^{j 12 π \text{/} 8} \\ {e}^{j 6 π \text{/} 8} \\ {e}^{j 15 π \text{/} 8} \\ {e}^{j 1 π \text{/} 8}\end{matrix} ] & [ Equation 5 ]\end{matrix}$$

The channel status information generating unit 130 may generate, to be channel status information, quantized vectors obtained by transforming the eigenvectors calculated by the eigenvector calculator 132 from the channel matrix through use of amplitude information and phase information, quantized vectors obtained by transforming the eigenvectors through use of only phase information having high-precision, or information designating the vectors, for example, a codebook. The feedback unit 140 may feed back the channel status information.

In this example, a scheme of transmitting the vectors quantized through use of the amplitude information and the phase information based on the former scheme or the information designating the vectors may transmit a more accurate shape of an eigenvector when compared to a scheme of transmitting the vectors quantized through use of only the phase information based on the latter scheme or the information designating the vectors. However, power balancing may be more difficult in the MU-MIMO scheme than in the SU-MIMO scheme, which will be described in detail.

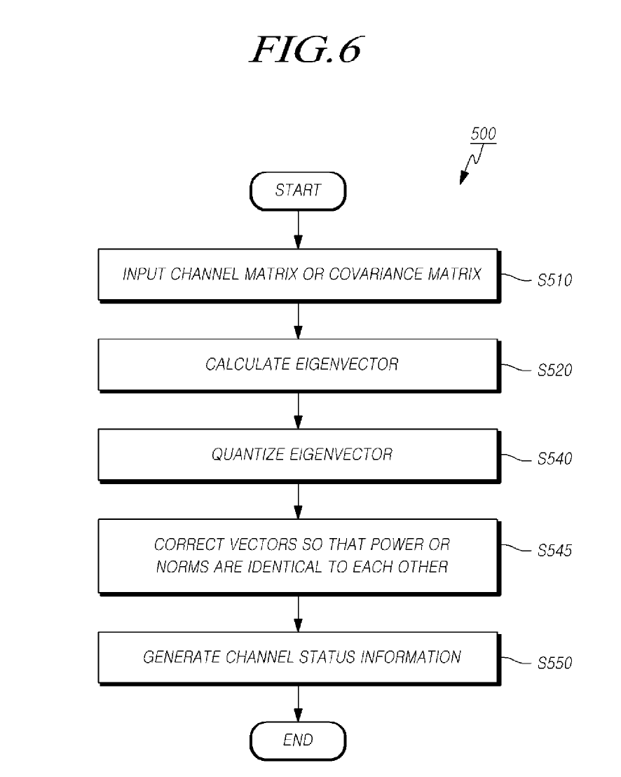

For example, in the case of the MU-MIMO scheme that selects each of vectors corresponding to a larger eigen-value from among eigenvectors fed back by each UE having 4 antennas, for example, each of vectors of Equation 6, and supports rank 1 transmission for two UEs, it is assumed that the BS performs precoding through use of an eigenvector of FIG. 6.

$$\frac{1}{\sqrt{10}} [ \begin{matrix}2 {e}^{j π \text{/} 4} \\ {e}^{j 7 π \text{/} 4} \\ 2 {e}^{j π \text{/} 4} \\ {e}^{j 3 π \text{/} 4}\end{matrix} ] , \frac{1}{\sqrt{10}} [ \begin{matrix}2 {e}^{j 2 π \text{/} 4} \\ {e}^{j 2 π \text{/} 4} \\ {e}^{j 4 π \text{/} 4} \\ 2 {e}^{j 7 π \text{/} 4}\end{matrix} ] \qquad [ Equation 6 ]$$

In this example, a maximum transmission power of two transmit antennas of each UE may be (2+2)2:(1+1)2=16:4, and one may have transmission power four times greater than the other. The large difference in the maximum transmission power of the transmit antennas of each UE may dramatically decrease an output efficiency of a power amplifier of a transmitting end. Generally, each transmit antenna may use a power amplifier having the same output and the same power, or two or more transmit antennas may share a single power amplifier.

As described in the foregoing, when a precoder of which antennas have different transmission power is used, a maximum transmission output of each of 4 is transmit antennas may be 16:4:9:9 based on Equation 6. When each of the four transmit antennas uses a power amplifier having a maximum output of P, a power amplifier that is in charge of second antenna transmission may transmit a signal through use of power of P/4, power amplifiers that are in charge of third and fourth transmission antennas may transmit a signal through use of power of 9P/16 and thus, power amplifiers that are in charge of transmission of all the four antennas may transmit a signal through use of power of 19P/8. In this example, the total of 19P/8 may be 60% of the maximum output of the power amplifiers of 4P and thus, transmission efficiency of the power amplifiers of the BS may be dramatically decreased.

When amplitude information of the eigenvector is distorted to enable the transmission power of transmit antennas to be the same and to overcome the decrease in transmission efficiency in a power amplifier of a BS, precoding performance may to decrease and MAI may increase.

To solve the problem, quantization may be performed through use of only a phase component irrespective of an amplitude component of an eigenvector, and a scheme of performing feedback by increasing precision of the phase component, for example, the scheme of feeding back the eigenvector of Equation 5 may be used.

In this example, the scheme of transmitting the information designating the vectors quantized through use of the amplitude information and the phase information based on the former scheme may use 1 bit for the amplitude information and 3 bits for the phase information, whereas the scheme of transmitting the information designating the vectors quantized through use of only the phase information may use 4 bits for the phase information so as to increase reliability of the phase information.

However, an accuracy of the eigenvector for the same feedback overhead may decrease and thus, this scheme may be inappropriate for supporting the SU-MIMO scheme.

The channel status information generating unit 130 may generate channel status information that feeds back feedback information that is appropriate for or supports the SU-MIMO scheme, and that includes feedback information that is appropriate for or supports the MU-MIMO in a portion of the channel status information. For example, the channel status information generating unit 130 may design a codebook for the MU-MIMO scheme and a codebook for the SU-MIMO, to have different characteristics. Therefore, the feedback information may be a single piece of feedback information that supports the SU-MIMO, and may have two codebooks having different characteristics. One codebook may be a power balanced codebook of an inside of a layer (a vector), and the other codebook may be a codebook that accurately reflects a shape of an eigenvector.

Referring again to FIG. 3, the eigenvector calculator 132 may select a predetermined number of eigenvectors having large eigen-values from among eigenvectors of a channel matrix, as first eigenvectors or prime eigenvectors. Remaining eigenvectors may be selected as second eigenvectors or minor eigenvectors. A number of the prime eigenvectors may be a number of layers that each UE may simultaneously receive when the MU-MIMO scheme operates, or may be a number of eigenvectors of which eigen-values are greater than a threshold, or a value that is smaller than the other from among the described two numbers. For example, when the number of layers that a UE is capable of receiving while the MU-MIMO scheme operates is assumed to be up to two, the eigenvector calculator 132 may select two eigenvectors corresponding to two largest eigen-values as prime eigenvectors, and may select remaining eigenvectors as minor eigenvectors. The prime eigenvectors may be component vectors having a relatively excellent channel status, selected from among component vectors of the channel matrix.

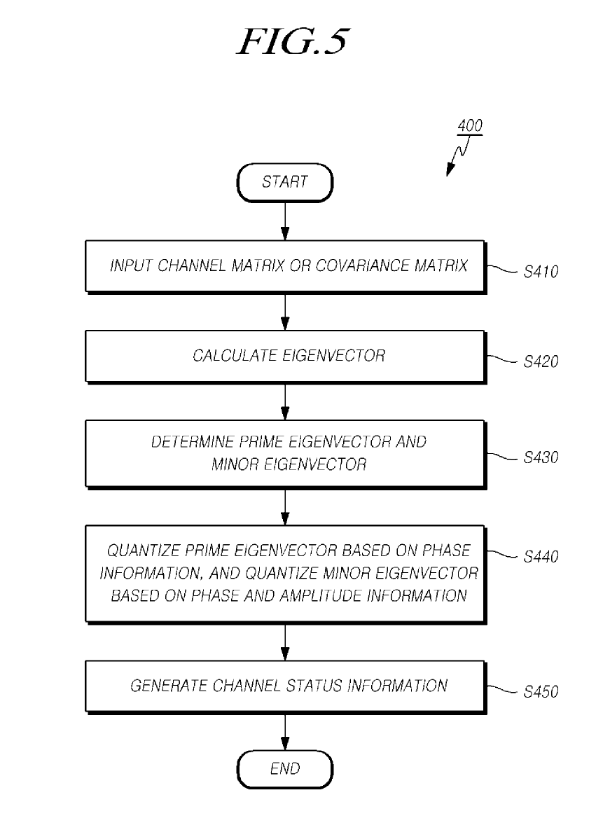

For example, the eigenvector calculator 132 may select two eigenvectors corresponding to two largest eigen-values from among eigenvectors of FIG. 5 as prime eigenvectors, and may select remaining eigenvectors as minor eigenvectors, as shown in Equation 7. In this example, the eigen-value may be a value indicating a gain associated with a channel of an eigenvector. That is, when precoding is performed through use of an eigenvector corresponding to a large eigen-value, a signal may have a high reception power after passing the channel.

$$\underbrace{\frac{1}{3} [ \begin{matrix}2.4 ∠52° \\ 0.8 ∠314° \\ 1.6 ∠37° \\ 0.2 ∠142°\end{matrix} ] \frac{1}{4} [ \begin{matrix}3.5 ∠27° \\ 1.8 ∠284° \\ 0.4 ∠62° \\ 0.6 ∠154°\end{matrix} ]}_{Prime eigen vectors} \underbrace{\frac{1}{3} [ \begin{matrix}1.6 ∠84° \\ 1.3 ∠96° \\ 0.5 ∠196° \\ 2.1 ∠312°\end{matrix} ] \frac{1}{3} [ \begin{matrix}1.5 ∠271° \\ 2.4 ∠142° \\ 0.8 ∠342° \\ 0.6 ∠28°\end{matrix} ]}_{Minor eigen vectors} \qquad [ Equation 7 ]$$

The first quantizing unit 134 may quantize the selected prime eigenvectors based on phase information (or a phase component), and the second quantizing unit 136 may quantize the selected minor eigenvectors based on amplitude information (or an amplitude component) and phase information (a phase component). A vector obtained through quantization by the first quantizing unit 134 may be a first vector, and a vector obtained through quantization by the second quantizing unit 135 may be a second vector. In this example, the first quantizing unit 134 may perform quantization based on, for example, 16 pieces of phase information, and the second quantizing unit 136 may perform quantization based on, for example, 8 pieces of phase information and thus, quantization levels may be different from each other. However, embodiments of the present invention may not be limited thereto. For example, quantization levels of the first quantizing unit 134 and the second quantizing unit 136 may be the same.

As described in the foregoing, the first vector obtained when the first quantizing unit 134 quantizes the prime eigenvectors from among the eigenvectors of Equation 7 may be as shown in Equation 8, and the second vector obtained when the second quantizing unit 136 quantizes the minor eigenvectors from among the eigenvectors of Equation 7 may be as shown in Equation 9.

$$\begin{matrix}[ \begin{matrix}{e}^{j 1 π \text{/} 8} & {e}^{j π \text{/} 8} \\ {e}^{j 13 π \text{/} 8} & {e}^{j 13 π \text{/} 8} \\ {e}^{j 2 π \text{/} 8} & {e}^{j 3 π \text{/} 8} \\ {e}^{j 6 π \text{/} 8} & {e}^{j 7 π \text{/} 8}\end{matrix} ] & [ Equation 8 ] \\ \frac{1}{\sqrt{10}} [ \begin{matrix}2 {e}^{j 2 π \text{/} 4} & {e}^{j 6 π \text{/} 4} \\ {e}^{j 2 π \text{/} 4} & 2 {e}^{j 3 π \text{/} 4} \\ {e}^{j 4 π \text{/} 4} & 2 {e}^{j 8 π \text{/} 4} \\ 2 {e}^{j 7 π / 4} & {e}^{j π \text{/} 4}\end{matrix} ] & [ Equation 9 ]\end{matrix}$$

The second quantizing unit 136 may correct amplitude of the second vector so that norms of row vectors or column vectors of the first vector and the second vector become identical to one another. Also, the second quantizing unit 136 may correct, change, or adjust the amplitude of the second vector so that transmission power of the row vectors or column vectors of the first vector and the second vector become identical to each other. In other words, the second quantizing unit 136 may correct, change, or adjust the amplitude of the second vector so that transmission power of each layer or each antenna become identical to one another.

For example, when transmission power of a second antenna is greater than transmission power of remaining antennas as shown in the former part of FIG. 10, the second quantizing unit 136 may generate a second vector by decreasing amplitude value so that the transmission power of the second antenna becomes identical to transmission power of remaining antennas as shown in the latter part of FIG. 10.

$$\frac{1}{\sqrt{10}} [ \begin{matrix}2 {e}^{j 2 π \text{/} 4} & {e}^{j 6 π \text{/} 4} \\ 2 {e}^{j 2 π \text{/} 4} & 2 {e}^{j 3 π \text{/} 4} \\ {e}^{j 4 π \text{/} 4} & 2 {e}^{j 8 π \text{/} 4} \\ 2 {e}^{j 7 π \text{/} 4} & {e}^{j π \text{/} 4}\end{matrix} ] \to \frac{1}{\sqrt{10}} [ \begin{matrix}2 {e}^{j 2 π \text{/} 4} & {e}^{j 6 π \text{/} 4} \\ {e}^{j 2 π \text{/} 4} & 2 {e}^{j 3 π \text{/} 4} \\ {e}^{j 4 π \text{/} 4} & 2 {e}^{j 8 π \text{/} 4} \\ 2 {e}^{j 7 π \text{/} 4} & {e}^{j π \text{/} 4}\end{matrix} ] \qquad [ Equation 10 ]$$

The channel status information generating unit 130 may select prime eigenvectors and minor eigenvectors from among the eigenvectors, may quantize the selected prime eigenvectors and minor eigenvectors based on different characteristic or different schemes, and may correct an amplitude value of a few components of a vector as illustrated in Equation 10. However, embodiments of the present invention may not be limited thereto. For example, the channel status information generating unit 130 may quantize the eigenvectors based on the same schemes as shown in Equation 4 and Equation 5, and may correct an amplitude value of a few components of vectors that are quantized to have the same transmission power (or norm) between row vectors or column vectors.

Referring again to FIG. 2, the feedback unit 140 may feed back the first vector or the second vector (or corrected vectors), or may feed back information designating the first vector or the second vector, for example, two codebooks or indices of the first vector or the second vector. In this example, the feedback unit 140 may simultaneously or sequentially transmit the first vector or the second vector, or the information designating the first vector or the second vector. The feedback unit 140 may transmit the first vector or the second vector, or the information designating the first vector or the second vector based on the same transmission period or different transmission periods.

The channel status information feedback apparatus in an MIMO system according to an embodiment of the present invention has been described. Hereinafter, a channel status information feedback method in the MIMO system according to an embodiment of the present invention will be described.

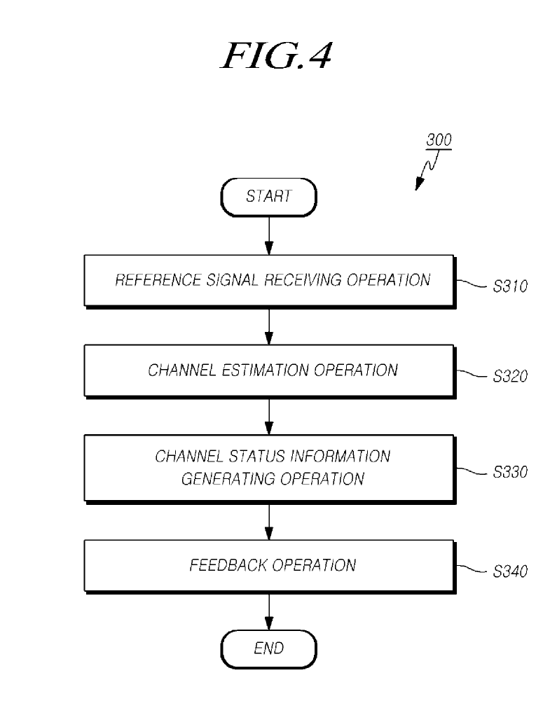

FIG. 4 illustrates a channel status information feedback method in a MIMO system according to another embodiment of the present invention.

An MU-MIMO channel status information feedback method 300 may include a reference signal receiving operation (step S310) that receives, from a BS, a reference signal, for example, a CSI-RS, a channel estimation operation (step S320) that estimates a channel based on the received CSI-RS, a channel status information generating operation (step S330) that generates channel status information based on a result of the channel estimation of the channel estimation operation (step S320), and a feedback operation (step S340) that feeds back the channel status information.

The reference signal receiving operation (step S310) and the channel estimation operation (step S320) may be embodied separately or integrally, and may be embodied integrally as occasion demands.

The reference signal receiving operation (step S310) may receive a CSI-RS unique to a cell, and may have information associated with at which band (subcarrier) of a reception signal and at which symbol the CSI-RS is received and thus, may measure a CSI-RS reception value by determining a signal of a corresponding time-frequency domain.

The channel estimation operation (step S320) may estimate a channel based on the received CSI-RS, and may perform channel estimation as follows. The CSI-RS reception value received in reference signal receiving operation (step S310) may be as described in Equation 1. A propagation channel H, which is a channel estimation result of the channel estimation operation (step S320) may be a channel matrix or a covariance matrix.

Subsequently, the channel status information generating operation (step 5330) may generate channel status information based on a result of the channel estimation of the channel estimation operation (step S320). The channel status information may include a first vector that is obtained by transforming, based on a predetermined scheme, a component vector associated with a few of an m number of layers and an n number of antennas in a channel matrix indicating a DL channel status transmitted through the m layers and the n antennas, and a second vector obtained by transforming, based on another scheme, a component vector associated with another few of the m layers and the n antennas in the channel matrix, m being a natural number greater than or equal to 2 and n being a natural number greater than or equal to m, or the channel status information may include information designating the first vector and the second vector. The channel status information may include a vector that has row vectors having the same power and that is obtained by transforming component vectors of the channel matrix that indicates the DL channel status transmitted through the m layers and the n antennas. The channel status information may include a CQI value.

A few operations performed by the channel status information feedback apparatus in the MIMO system according to an embodiment of the present invention have been described. Hereinafter, examples of a channel status information generating operation, which is one of the operations included in the channel status information feedback method in the MIMO system, will be described.

FIG. 5 illustrates an example of a channel status information generating method according to another embodiment of the present invention. A channel status information generating method 400 may correspond to a portion of the channel status information generating operation (step S340), and simultaneously, may configure an independent method. In other words, the channel status information generating method 400 of FIG. 5 may configure a method that is independent from a pre-operation and a post-operation of the channel status information generating operation (step S340), and the channel status information generating method 400 may be included in embodying of another technology.

Referring to FIGS. 4 and 5, input of a channel matrix or a covariance matrix, which is a result of channel estimation of the channel estimation operation (step S320), may be received (step S410).

Subsequently, an eigenvector or a unique vector (characteristic vector) of the channel matrix or the covariance matrix may be calculated (step S420). For example, the step S420 may calculate the eigenvector of the channel matrix through use of a Hermitian matrix formed by multiplication of the channel matrix having a conjugate transpose as shown in Equation 2. For example, with respect to a channel formed of 4 layers (m=4) and 4 antennas (n=4), eigenvectors of the channel matrix or the covariance matrix may be as shown in Equation 3.

Subsequently, a predetermined number of eigenvectors having large eigen-values from among the eigenvectors of the channel matrix may be selected as first eigenvectors or prime eigenvectors, and remaining eigenvectors may be selected as second eigenvectors or minor eigenvectors (step S430). A number of the prime eigenvectors may be a number of layers that each user may simultaneously receive when an MU-MIMO scheme operates, or may be a number of eigenvectors of which eigen-values are greater than a threshold, or may be a value that is smaller than the other from among the described two numbers. For example, when the maximum number of layers that a UE is capable of receiving while the MU-MIMO operates is assumed to be up to two, two eigenvectors corresponding to the two largest eigen-values may be selected as prime eigenvectors, and remaining eigenvectors may be selected as minor eigenvectors.

For example, two eigenvectors corresponding to two largest eigen-values from among eigenvectors of FIG. 5 may be selected as prime eigenvectors, and remaining eigenvectors may be selected as minor eigenvectors, as shown in Equation 7.

Subsequently, the selected prime eigenvectors may be quantized based on phase information (or a phase component), and the selected minor eigenvectors may be quantized based on amplitude information (or an amplitude component) and phase information (a phase component) (step S440). A vector obtained through quantization based on the former scheme may be referred to as a first vector, and a vector obtained through quantization based on the latter scheme may be referred to as a second vector.

As described in the foregoing, the first vector obtained by quantizing the prime eigenvectors from among the eigenvectors of Equation 7 may be as shown in Equation 8, and the second vector obtained by quantizing the minor eigenvectors from among the eigenvectors of Equation 7 may be as shown in Equation 9.

Subsequently, the first vector or the second vector (or a corrected vector), or information designating the first vector or the second vector may be generated as channel status information (step S450). As an example of the information, two codebooks or indices of the first vector or the second vectors may be generated as the channel status information.

An example of the channel status information generating operation, which is one of the operations included in the channel status information feedback method in the MIMO system according to an embodiment of the present invention, has been described. Hereinafter, another example of a channel status information generating operation, which is one of the operations of the channel status information feedback method in the MIMO system according to an embodiment of the present invention, will be described.

FIG. 6 illustrates another example of a channel status information generating method according to another embodiment of the present invention.

Referring to FIGS. 4 and 6, input of a channel matrix or a covariance matrix, which is a result of the channel estimation of the channel estimation operation (step S320) may be received (step S510).

Subsequently, an eigenvector or a unique vector (a characteristic vector) of the channel matrix or the covariance matrix may be calculated (step S520).

Subsequently, eigenvectors of the channel matrix may be quantized (step S540). A quantization scheme used in the step S540 may not be limited. For example, the quantization scheme in step S540 may include a scheme of performing quantization based on amplitude information (or an amplitude component) and phase information (or a quantization component) as shown in Equation 4, a scheme of performing quantization based on phase information (or a phase component) as shown in Equation 5, a scheme of separately performing quantization with respect to first eigenvectors and second eigenvectors based on different schemes, and any combination thereof.

Subsequently, amplitude of components of the eigenvectors may be corrected so that power or norms of the quantized eigenvectors become identical to each other (step S545).

For example, when transmission power of a second antenna is greater than transmission power of remaining antennas as shown in the former part of FIG. 10, a vector may be generated by decreasing an amplitude value so that the transmission power of the second antenna becomes identical to the transmission power of remaining antennas as shown in the latter part of FIG. 10.

Subsequently, the vector obtained by correcting amplitude of the components of the eigenvectors so that the power or norms of the quantized eigenvectors become identical to each other, or information designating the vector may be generated as channel status information (step S550). As an example of the information, a codebook of the vector may be generated as the channel status information.

Referring again to FIG. 4, after the channel status information generating operation (step S330) according to the channel status information generating methods 400 and 500 described with reference to FIGS. 5 and 6, the channel status information generated based on the channel status information generating methods 400 and 500 may be fed back (step S340). In this example, component vectors of the channel status information or information designating the vectors may be simultaneously or sequentially transmitted. A transmission period of each of the component vectors of the channel status information or the information designating the vectors may be the same as or different from one another.

The channel status information feedback method in the MIMO system according to an embodiment of the present invention has been described. Hereinafter, a BS according to another embodiment of the present invention will be described.

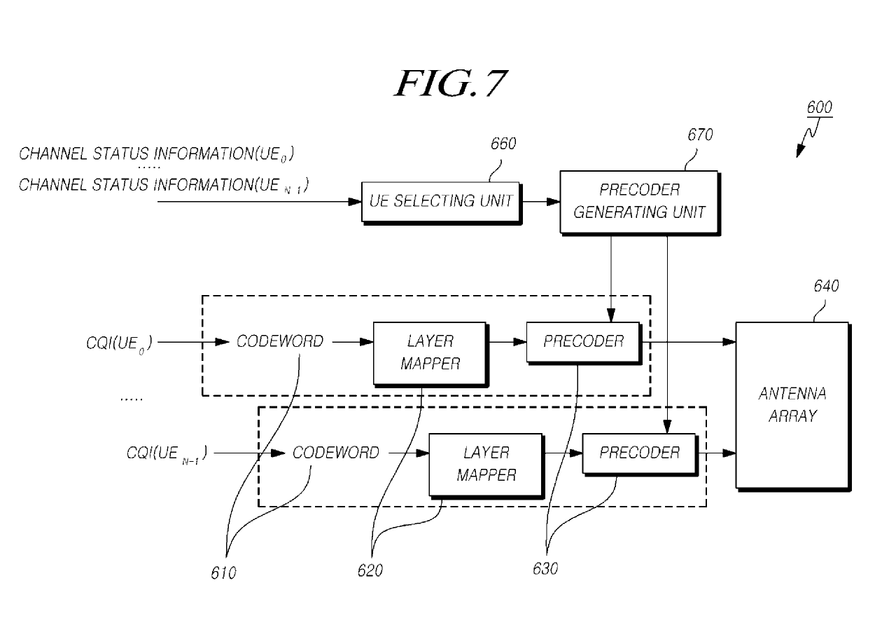

FIG. 7 illustrates a BS according to another embodiment of the present invention.

The BS or a BS device 600 may include a layer mapper 620 to perform mapping of a codeword 610 on a layer, a precoder 630 to perform precoding of symbols, and an antenna array 640 including two or more antennas that propagate precoded symbols into air. The layer mapper 620, the precoder 630, and the antenna array 640 may be the same or substantially the same as a current or future general configuration and thus, detailed descriptions thereof will be omitted.

Each UE may transfer, to the BS 600, channel status information associated with a propagation channel or a channel matrix, based on the described method. Also, each UE may measure a channel capacity or a channel quality through use of a reference signal, and may report the measured value to the BS through a CQI as another piece of channel status information.

The BS 600 may include a UE selecting unit 660 and a precoder generating unit 670.

The UE selecting unit 660 may determine whether to perform SU-MIMO transmission or MU-MIMO transmission based on the CQIs and channel status information reported from each UE, and may select corresponding UEs. When the SU-MIMO transmission is determined, the UE selecting unit 660 may select a single UE. When the MU-MIMO transmission is selected, the UE selecting unit 660 may compare CQIs and channel status information reported from each UE, and may recognize correlation between channels of the UEs. The UE selecting unit 660 may select UEs that satisfy a predetermined condition based on the correlation between the channels of the UEs. In this example, the UEs that satisfy the predetermined condition may indicate UEs that have least channel interference between the UEs, but this may not be limited thereto.

The precoder generating unit 670 may generate a precoding matrix of the UE(s) selected by the UE selecting unit 660. In this example, the precoder generating unit 670 may generate the precoding matrix of the UE(s) based on the channel status information reported from the UEs selected by the UE selecting unit 660.

The channel status information may include a first vector obtained by quantizing, based on a predetermined scheme, a component vector associated with a few of an m number of layers and an n number of antennas in a channel matrix that indicates a DL channel status transmitted through the m layers and the n antennas and reported from the UEs, and a second vector obtained by quantizing, based on another scheme, a component vector associated with another few of the m layers and the n antennas in the channel matrix, m being a natural number greater than or equal to 2 and n being greater than or equal to m, or the channel status information may include information designating the vectors, for example, a codebook or an index.

Also, the channel status information may include a vector that has row vectors having the same power and that is quantized from the channel matrix that indicates a DL channel status transmitted through the m layers and the n antennas and reported from the UEs, or information designating the vector, for example, a codebook or an index.

In the case of a conventional scheme that receives a channel or covariance matrix, a representative precoding scheme may obtain an eigenvector of a channel and may perform precoding based on the eigenvector, or may obtain an inverse matrix of a reception channel or covariance matrix and may perform zero-forcing precoding. The precoding based on the eigenvector from among the schemes may have a larger feedback overhead when compared to the scheme of feeding back the eigenvector according to the embodiments of the present invention, and may have low power efficiency, low transmission power, and low reception power due to the described characteristics. Also, the zero-forcing scheme may have an excellent interference control capability but may be vulnerable to thermal noise and thus, may show poorer performance than the precoding based on the eigenvector in most systems.

The BS according to another embodiment of the present invention has been described. Hereinafter, a transmission method of the BS according to another embodiment of the present invention will be described.

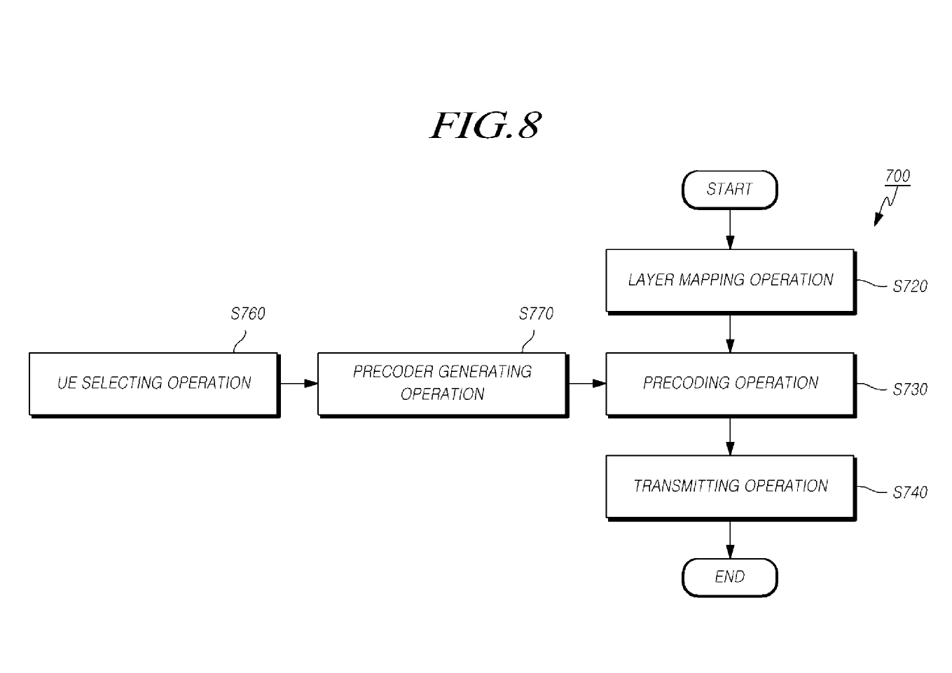

FIG. 8 illustrates a transmission method of a BS according to another embodiment of the present invention.

Referring to FIG. 8, a transmission method 700 of the BS may include a layer mapping operation (step S720) that performs mapping of a codeword 610 on a layer, a precoding operation (step S730) that performs precoding of symbols, and a transmitting operation (step S740) that propagates the precoded symbols into air through two or more antennas. The layer mapping operation (step 720), the precoding operation (step S730), and the transmitting operation (step S740) may be the same or substantially the same as a current or future general configuration and thus, detailed descriptions thereof will be omitted.

Also, the transmission method 700 of the BS according to another embodiment of the present invention may include a UE selecting operation (step S760) and a precoder generating operation (step S770).

The UE selecting operation (step S760) may determine whether to perform SU-MIMO transmission or MU-MIMO transmission, based on CQIs and channel status information reported from each UE. When the SU-MIMO transmission is determined, the UE selecting operation (step S760) may select a single UE. When the MU-MIMO transmission is determined, the UE selecting operation (step S760) may compare CQIs and the channel status information reported from each UE and may recognize correlation between channels of the UEs. The UE selecting operation (step S760) may select UEs that satisfy a predetermined condition based on the correlation between the channels of the UEs. In this example, the UEs that satisfy the predetermined condition may be UEs that have the least channel interference between the UEs, but this may not be limited thereto.

The precoder generating operation (step S770) may generate a precoding matrix of the UE(s) selected in the UE selecting operation (step S760). In this example, the precoder generating operation (step S770) may generate a precoding matrix of the UE(s) based on channel status information reported from the UEs selected in the UE selecting operation (step S760).

The channel status information may include a first vector obtained by quantizing, based on a predetermined scheme, a component vector associated with a few of an m number of layers and an n number of antennas in a channel matrix that indicates a DL channel status transmitted through the m layers and the n antennas and reported from the UEs, and a second vector obtained by quantizing, based on another scheme, a component vector associated with another few of the m layers and the n antennas in the channel matrix, m being a natural number greater than or equal to 2 and n being greater than or equal to m, or the channel status information may include information designating the vectors, for example, a codebook or an index.

Also, the channel status information may include a vector that has row vectors having the same power and that is quantized from the channel matrix that indicates a DL channel status transmitted through the m layers and the n antennas and reported from the UEs, or information designating the vector, for example, a codebook or an index.

In the case of a conventional scheme that receives a channel or covariance matrix, a representative precoding scheme may obtain an eigenvector of a channel and may perform precoding based on the eigenvector, or may obtain an inverse matrix of a reception channel or covariance matrix and may perform zero-forcing precoding. The precoding based on the eigenvector from among the schemes may have a larger feedback overhead when compared to the scheme of feeding back the eigenvector according to the embodiments of the present invention, and may have low power efficiency, low transmission power, and low reception power due to the described characteristics. Also, the zero-forcing scheme may have an excellent interference control capability but may be vulnerable to thermal noise and thus, may show poorer performance than the precoding based on the eigenvector in most systems.

Although the embodiments of the present invention have been described with reference to the accompanying drawings, the embodiments of the present invention may not be limited thereto.

The embodiments of the present invention may be applicable to a UL/DL MIMO system, and may be applicable to all UL/DL MIMO systems such as a single cell environment, a coordinated multi-point transmission/reception system (CoMP) and heterogeneous network, and the like.

Although the embodiments of the present invention describe that an eigenvector of a channel matrix or a covariance matrix is quantized and fed back, the eigenvector itself may be fed back without quantizing the eigenvector. In this example, eigenvectors for an SU-MIMO scheme may be fed back by including a few eigenvectors for an MU-MIMO scheme and thus, the same effect as described in the foregoing may be obtained.

Although the embodiments of the present invention describes component vectors of a matrix for the SU-MIMO scheme include a few components for the MU-MIMO scheme, the embodiments of the present invention may not be limited thereto, and component vectors of a matrix for the MU-MIMO scheme may include a few component vectors for the SU-MIMO scheme.

Although exemplary embodiments of the present invention have been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of feeding back channel status information, the method comprising:
generating a first vector by transforming, based on a predetermined scheme, a component vector associated with a few of an m number of layers and an n number of antennas in a channel matrix indicating a downlink (DL) channel status transmitted through the m layers and the n antennas, m being a natural number greater than or equal to 2 and n being a natural number greater than or equal to m;
generating a second vector by transforming, based on another scheme, a component vector associated with another few of the m layers and the n antennas in the channel matrix; and
transmitting, to a base station (BS), the first vector and the second vector, or information designating the first vector and the second vector.

2. The method as claimed in claim 1, wherein the channel matrix is an eigenvector.

3. The method as claimed in claim 1, wherein the predetermined scheme used for the first vector quantizes only a phase of the channel matrix; and the other scheme used for the second vector quantizes the phase and amplitude of the channel matrix.

4. The method as claimed in claim 1, wherein power of row vectors of the first vector and the second vector are the same.

5. The method as claimed in claim 1, wherein the component vector associated with the first vector is a component vector having a relatively excellent channel status, selected from among component vectors of the channel matrix.

6. The method as claimed in claim 3, wherein the first vector and the second vector are quantized to be the same level or to be different levels.

7. The method as claimed in claim 1, wherein the information designating the first vector and the second vector includes two indices designating the first vector and the second vector, or includes a single index designating the first vector and the second vector.

8. The method as claimed in claim 1, further comprising:
transmitting, to the BS, the first vector and the second vector, or the information associated with the first vector and the second vector, at the same point in time or at different points in time.

9. A method of feeding back channel status information, the method comprising:
generating a vector that has row vectors having the same power, and that is transformed from a channel matrix indicating a downlink (DL) channel status transmitted through m layers and n antennas, m being a natural number greater than or equal to 2 and n being a natural number greater than or equal to m; and
transmitting, to a base station (BS), the vector or information designating the vector, at the same point in time or at different points in time.

10. The method as claimed in claim 9, wherein the vector includes a first vector obtained by quantizing a component vector associated with a few of the m layers and the n antennas in the channel matrix, and a second vector obtained by quantizing a component vector associated with another few of the m layers and the n antennas in the channel matrix.

11. An apparatus for feeding back channel status information in a wireless communication system, the apparatus comprising:
a reference signal receiving unit to receive a reference signal from a base station (BS);
a channel estimation unit to estimate a channel based on the received reference signal;
a channel status information generating unit to generate channel status information including a first vector obtained by transforming, based on a predetermined scheme, a component associated with a few of an m number of layers and an n number of antennas in a channel matrix indicating a downlink (DL) channel status transmitted through the m layers and the n antennas based on a result of the channel estimation of the channel estimating unit, and a second vector obtained by transforming, based on another scheme, a component vector associated with another few of the m layers and the n antennas in the channel matrix, m being a natural number greater than or equal to 2 and n being a natural greater than or equal to m; and
a feedback unit to feed back the generated channel status information.

12. The apparatus as claimed in claim 11, wherein the channel matrix is an eigenvector.

13. The apparatus as claimed in claim 11, wherein the predetermined scheme for the first vector quantizes only a phase of the channel matrix; and
the other scheme for the second vector quantizes the phase and amplitude of the channel matrix.

14. The apparatus as claimed in claim 11, wherein power of row vectors of the first vector and the second vector are the same.

15. The apparatus as claimed in claim 11, wherein the component vector associated with the first vector is a component vector having a relatively excellent channel status, selected from among component vectors of the channel matrix.

16. The apparatus as claimed in claim 13, wherein the first vector and the second vector are quantized to be the same level or different levels.

17. The apparatus as claimed in claim 11, wherein the information designating the first vector and the second vector includes two indices designating the first vector and the second vector, or includes a single index designating the first vector and the second vector.

18. The apparatus as claimed in claim 11, wherein the first vector and the second vector, or the information designating the first vector and the second vector are transmitted to a BS at the same point in time or at different points in time.

19. An apparatus for feeding back channel status information in a wireless communication system, the apparatus comprising:
a reference signal receiving unit to receive a reference signal from a base station (BS);
a channel estimation unit to estimate a channel based on the received reference signal;
a channel status information generating unit to generate channel status information including a vector that has row vectors having the same power, and that is transformed from a channel matrix indicating a downlink (DL) channel status transmitted through m layers and n antennas, m being a natural number greater than or equal to 2 and n being a natural number greater than or equal to m; and
a feedback unit to feed back the generated channel status information.

20. The apparatus as claimed in claim 19, wherein the vector includes a first vector obtained by quantizing a component vector associated with a few of the m layers and the n antennas in the channel matrix, and a second vector obtained by quantizing a component vector associated with another few of the m layers and the n antennas in the channel matrix.

21. A base station (BS) in a wireless communication system, the BS comprising:
a layer mapper to perform mapping of a codeword on a layer;
a precoder to perform precoding of mapped symbols based on a precoding matrix;
an antenna array including two or more antennas that propagate the precoded symbols into air; and
a precoder generating unit to generate a precoding matrix of user equipments (UEs) based on channel status information including a first vector obtained by transforming, based on a predetermined scheme, a component vector associated with a few of an m number of layers and an n number of antennas in a channel matrix indicating a downlink (DL) channel status, transmitted through the m layers and the n antennas and reported from the UEs, and a second vector obtained by transforming, based on another scheme, a component vector associated with another few of the m layers and the n antennas, m being a natural number greater than or equal to 2 and n being a natural number greater than or equal to m.

22. A base station (BS) in a wireless communication system, the BS comprising:
a layer mapper to perform mapping of a codeword on a layer;
a precoder to perform precoding of mapped symbols based on a precoding matrix;
an antenna array including two or more antennas that propagate the precoded symbols into air; and
a precoder generating unit to generate a precoding matrix of user equipments (UEs) based on channel status information including a vector that has row vectors having the same power, and that is transformed from a channel matrix indicating a downlink (DL) channel status transmitted through m layers and n antennas, m being a natural number greater than or equal to 2 and n being a natural number greater than or equal to m.

23. A transmission method in a wireless communication system, the method comprising:
mapping a codeword on a layer;
precoding mapped symbols based on a precoding matrix;
transmitting precoded symbols into air through use of an antenna array including two or more antennas; and
generating a precoding matrix of user equipments (UEs) based on channel status information including a first vector obtained by transforming, based on a predetermined scheme, a component vector associated with a few of an m number of layers and an n number of antennas in a channel matrix that indicates a downlink (DL) channel status, transmitted through the m layers and the n antennas and reported from the UEs, and a second vector obtained by transforming, based on another scheme, a component vector associated with another few of the m layers and the n antennas, m being a natural number greater than or equal to 2 and n being a natural number greater than or equal to m.

24. A transmission method in a wireless communication system, the method comprising:
mapping a codeword on a layer;
precoding mapped symbols based on a precoding matrix;
transmitting precoded symbols into air through an antenna array including two or more antennas; and
generating a precoding matrix of user equipments (UEs) based on channel status information including a vector that has row vectors having the same power, and that is transformed from a channel matrix indicating a downlink (DL) channel status transmitted through m layers and n antennas, m being a natural number greater than or equal to 2, and n being a natural number greater than or equal to m.
